(19) United States
(12) Patent Application Publication
(10) Pub. No.: US 2006/0271796 A1
(43) Pub. Date: Nov. 30, 2006

(54) Method and system for protecting information stored in an electronic device against backup and restore attack

(76) Inventors: Biju R. Kaimal, Emeryville, CA (US); Richard T. Chow, Santa Clara, CA (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/137,201

(22) Filed: May 25, 2005

(51) Int. Cl. G06F 12/14

(52) U.S. Cl. 713/194

(57) ABSTRACT

A method and system for protecting information in an electronic device (100) is provided. The method includes calculating a MAC value (112) of a meta-file (110). The meta-file comprises file information of at least one file (108) in the electronic device. The method further includes tagging the meta-file with an identifier value (206). The identifier value is the same as a value stored in a secure hardware monotonic counter (204).

### FIELD OF THE INVENTION

This invention relates in general to protection of information in electronic devices, and more specifically to prevention of backup and restore attacks in electronic devices.

### BACKGROUND OF THE INVENTION

With their increasing popularity, a large number of electronic devices such as mobile phones, pagers, personal digital assistants, etc., have been introduced in the market. These devices can store personal information of users, such as photographs, network service information, credit card information, and the like. The network service information enables the electronic device to access network services, based on billing options selected by users and the network services they subscribe to. Unfortunately, the storage of personal information in the electronic devices makes them targets for invasion of privacy.

An unauthorized user can potentially access the personal information stored in an electronic device if there is a weakness in the firmware controlling the operation of the electronic device. Such a weakness can typically be fixed by releasing software patches, firmware upgrades, and the like. However, a hacker or malicious user may take a backup of the firmware files with bugs, and may replace the patched, upgraded or updated newer file with the older backup version. This is known as a backup and restore attack, which enables unauthorized users to use certain network services without subscribing to those particular services. Users may restore network service information from a previous state of the electronic device, when they subscribed to various network services after unsubscribing from them. The restoration of older network service information enables continued use of unsubscribed network services by users, without their having to pay the required subscription costs.

Known methods for protecting personal information on electronic devices utilize a message authentication code (MAC) to secure sensitive files in the electronic devices. However, these methods do not provide protection against a backup and restore attack because the MAC protected file can itself be changed to an older copy.

### BRIEF DESCRIPTION OF THE FIGURES

In the accompanying figures, like reference numerals refer to identical or functionally similar elements throughout the separate views. These, together with the detailed description given below, are incorporated in, form a part of the specification, and serve to further illustrate the embodiments and explain various principles and advantages, in accordance with the present invention.

FIG. 1 is a block diagram illustrating an exemplary environment of an electronic device, in accordance with some embodiments of the present invention.

FIG. 2 is a block diagram illustrating an exemplary electronic device, in accordance with some embodiments of the present invention.

FIG. 3 is a flowchart illustrating a method for protecting information in an electronic device, in accordance with a first exemplary embodiment of the present invention.

FIGS. 4 and 5 depict a flowchart illustrating a method for protecting information in an electronic device, in accordance with a second exemplary embodiment of the present invention.

FIG. 6 is a block diagram of an electronic equipment, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular method and system for prevention of backup and restore attacks in electronic devices, in accordance with the present invention, it should be observed that the present invention resides primarily in combinations of method steps and system components related to protection of information in electronic devices. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

In accordance with an embodiment of the invention, a method for protecting information stored in an electronic device against backup and restore attack is disclosed. The method comprises calculating a message authentication code (MAC) value for a meta-file. The meta-file comprises file information for at least one file in the electronic device. The method further includes tagging the meta-file with an identifier value, which is the same as a counter value stored in a secure hardware monotonic counter in the electronic device.

In accordance with another embodiment of the invention, a system for protecting information stored in an electronic device is disclosed. The system comprises a secure hardware monotonic counter and a MAC key. The secure hardware monotonic counter is configured to store a value. The MAC key is stored in a protected hardware security module.

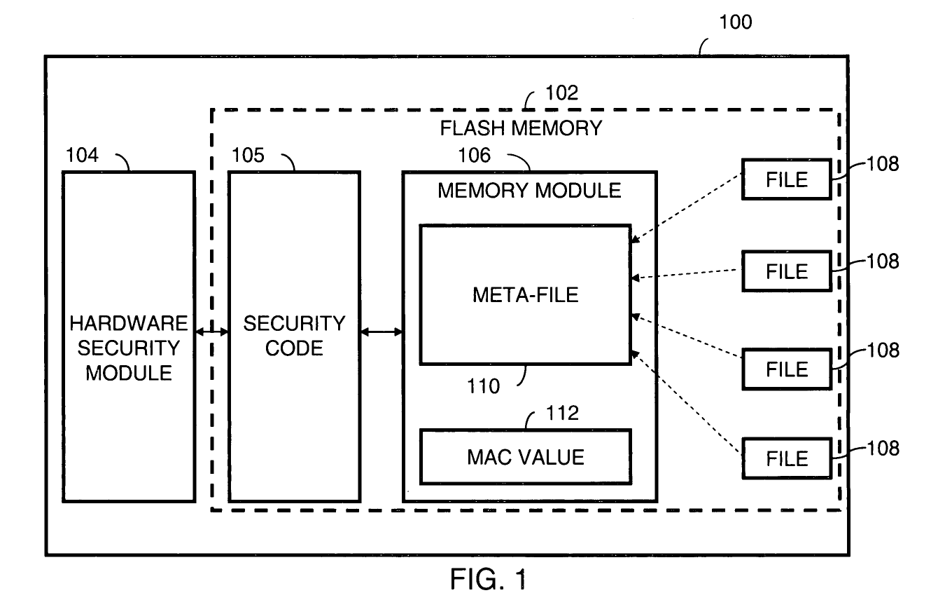

FIG. 1 is a block diagram illustrating an exemplary environment of an electronic device 100, in accordance with an embodiment of the present invention. The electronic device 100 includes a flash memory 102 that is used to store data in the electronic device 100. The electronic device 100 further includes a hardware security module 104. The flash memory 102 includes a security code 105, a memory module 106, and at least one file 108. The memory module 106 comprises a meta-file 110, which is used to store the file information of one or more files, such as the file 108. File information may include one or more of a group comprising key hashes, version information, cyclic redundancy check bits; and information pertaining to the size, the date of creation of the file the file 108, any authorized last modifications carried out on the file 108; and any other such characteristic information that may allow identification of the file 108. Further, the memory module 106 stores a MAC value 112 that is computed by the security code 105 for the meta-file 110, based on the file information of the meta-file 110.

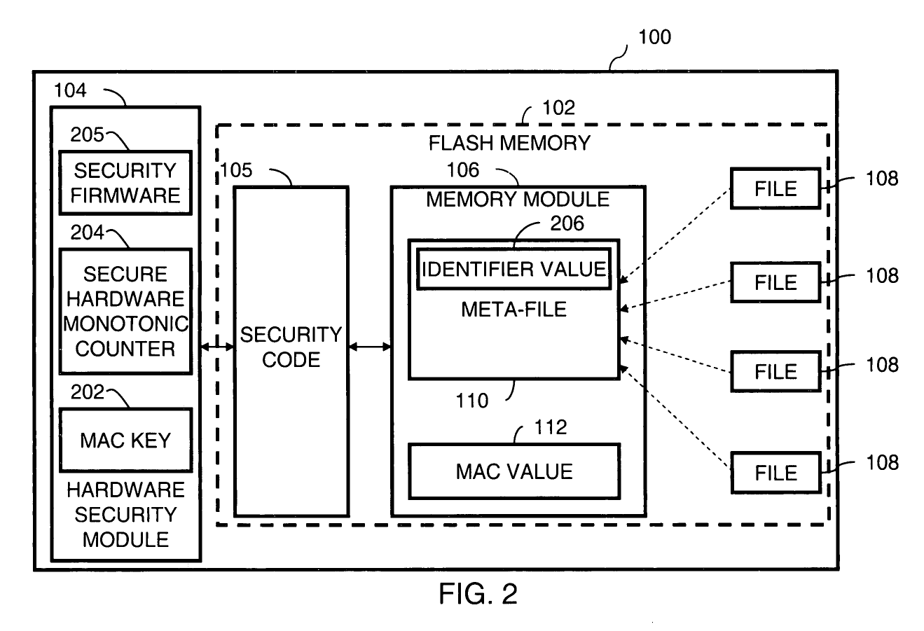

FIG. 2 is a block diagram illustrating the electronic device 100, in accordance with some embodiments of the present invention. The hardware security module 104 comprises a MAC key 202 and a secure hardware monotonic counter 204. The security code 105 accesses the MAC key 202 and the secure hardware monotonic counter 204 through a security firmware 205. The security code 105 calculates the MAC value 112 of the meta-file 110 utilizing the MAC key 202 that it accesses through the security firmware 205. The secure hardware monotonic counter 204 stores a value, which is used to identify an illegal copy of the meta-file 110, and can only be incremented. The meta-file 110 stores an identifier value 206, which is the same as the value stored in the secure hardware monotonic counter 204 that the security code 105 accesses through the security firmware 205. The identifier value 206 is incremented before incrementing the secure hardware monotonic counter 204. Incrementing the identifier value 206 in the meta-file 110 before incrementing the secure hardware monotonic counter 204 ensures that the identifier value 206 stored in the meta-file 110 is the same as the value stored in the secure hardware monotonic counter 204.

When the electronic device 100 is switched on, identification of an illegal copy of the file 108 is performed. The identification of an illegal copy of the file 108 is performed by the security code 105 by comparing a current file information for the file 108 with the file information stored in the meta-file 110. If this current file information of the file 108 and the file information stored in the meta-file matches, then a subsequent check is performed for identification of an illegal copy of the meta-file 110. The security code 105 calculates a MAC value 112 for the meta-file 110 utilizing the MAC key 202 contained in the hardware security module 104. The MAC key 202 is accessed by the security code 105 through the security firmware 205. The MAC value 112 calculated by utilizing the MAC key 202 is compared with the MAC value 112 stored in the memory module 106. If the MAC value 112, calculated by utilizing the MAC key 202, matches the MAC value 112 stored with the meta-file 110 in the memory module 106, then the security code 105 compares the identifier value 206 stored in the meta-file 110 with the counter value stored in the secure hardware monotonic counter 204 that the security code 105 accesses through the security firmware 205. If the identifier value 206 stored in the meta-file 110 is the same as the counter value of the secure hardware monotonic counter 204 that the security code 105 accesses through the security firmware 205, the operation of the electronic device 100 is allowed. If either of the checks between the calculated MAC value 112 and the MAC value 112 stored with the meta-file 110 in the memory module 106, and between the identifier value 206 stored in the meta-file 110 and the counter value of the secure hardware monotonic counter 204 gives a negative response, access to the file 108 is denied. Otherwise, access to the file 108 in the electronic device 100 is permitted. Denying access to the file 108 prevents the operation of the electronic device 100, and a backup and restore attack is prevented from compromising the security of the information stored in the electronic device 100.

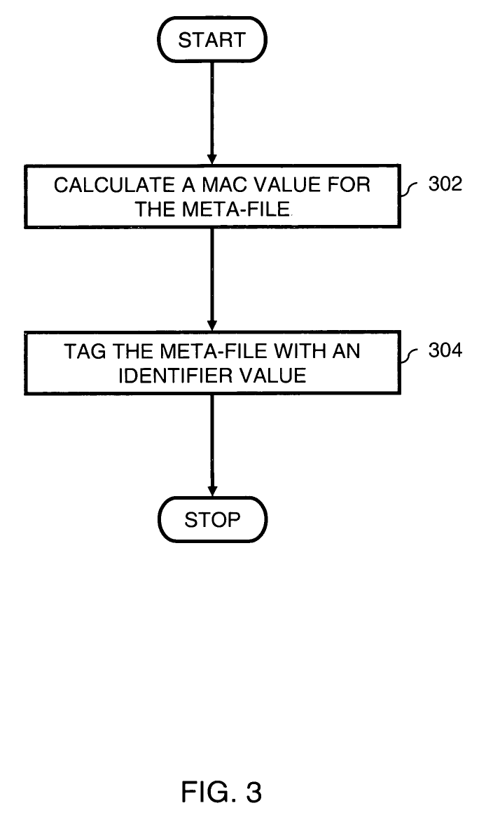

FIG. 3 is a flowchart illustrating a method for protecting information in the electronic device 100, in accordance with a first exemplary embodiment of the present invention. At step 302, the security code 105 calculates a MAC value 112 of the meta-file 110. The MAC value 112 is calculated by the security code 105, utilizing the MAC key 202 that is accessed through the security firmware 205. Thereafter, at step 304, the meta-file 110 is tagged with an identifier value 206 by storing the identifier value 206 in the meta-file 110. The identifier value 206 is the same as a value stored in the secure hardware monotonic counter 204 that the security code 105 accesses through the security firmware 205.

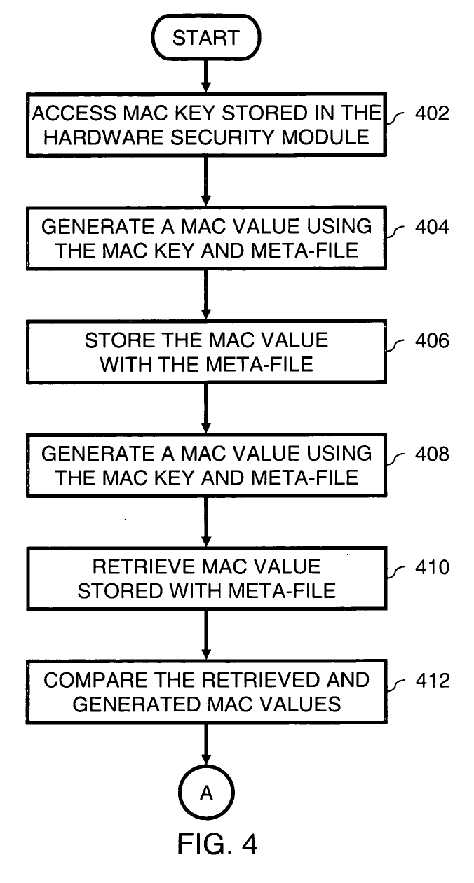

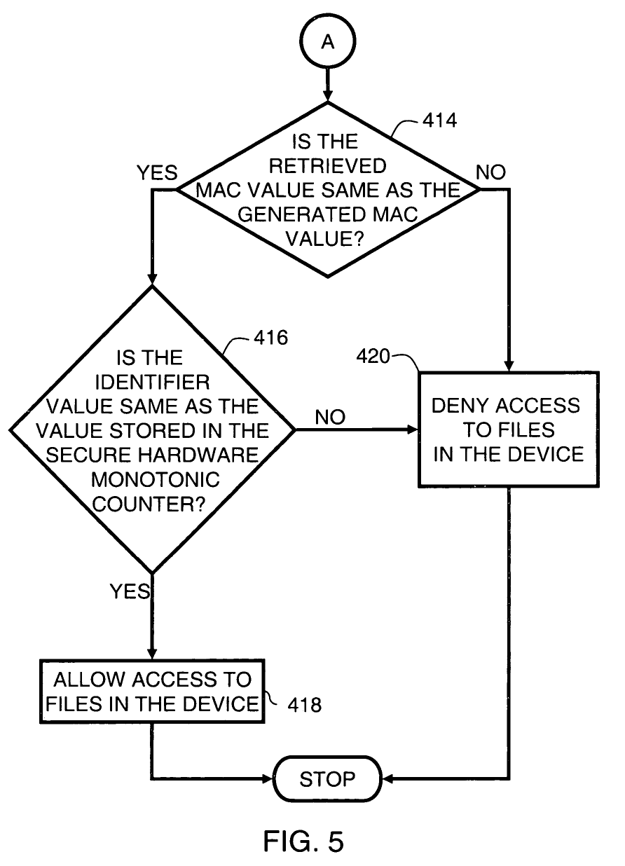

FIGS. 4 and 5 depict a flowchart illustrating a method for protecting information in the electronic device 100, in accordance with a second exemplary embodiment of the present invention. At step 402, the security code 105 accesses the MAC key 202 stored in the hardware security module 104 through the security firmware 205. At step 404, the security code 105 generates a MAC value 112 for the meta-file 110, utilizing the MAC key 202 that it accesses through the security firmware 205. The MAC value 112, generated at step 404, is stored with the meta-file 110 at step 406. Thereafter, the security code 105 generates a MAC value 112 for the meta-file 110, utilizing the MAC key 202 that it accesses through the security firmware 205 at step 408. At step 410, the security code 105 retrieves the MAC value 112 stored with the meta-file 110. At step 412, the MAC value 112 generated for the meta-file 110 is compared with the MAC value retrieved at step 410. At step 414, a check is carried out to verify whether the MAC value 112 retrieved at step 410 is the same as the MAC value 112 generated at step 408. If the MAC value 112 retrieved at step 410 is the same as the MAC value 112 generated at step 408, a check is carried out to verify whether the identifier value 206 stored in the meta-file 110 is the same as the value stored in the secure hardware monotonic counter 204 that the security code 105 accesses through the security firmware 205, at step 416. If the identifier value 206 stored in the meta-file 110 is the same as the value stored in the secure hardware monotonic counter 204, access to the file 108 in the electronic device 100 is allowed, at step 418. If either the identifier value 206 stored in the meta-file 110 is not the same as the value stored in the secure hardware monotonic counter 204, or the MAC value 112 retrieved at step 410 is not the same as the MAC value 112 generated at step 408, access to the file 108 in the electronic device 100 is denied at step 420, and any unauthorized access to the file 108 is prevented.

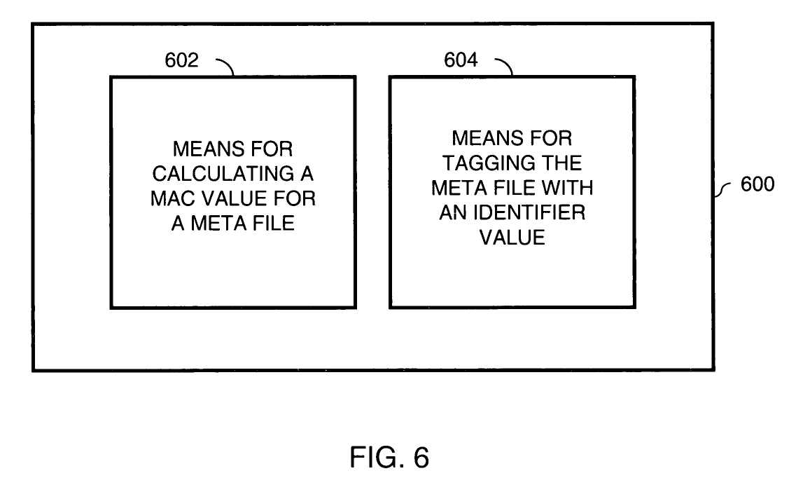

FIG. 6 is a block diagram of an electronic equipment 600, in accordance with some embodiments of the present invention. The electronic equipment 600 comprises a means for calculating 602 and a means for tagging 604. The means for calculating 602 calculates a MAC value 112 of the meta-file 110 utilizing the MAC key 202 that is accessed through the security firmware 205. The means for tagging 604 tags the meta-file 110 with an identifier value 206, which is the same as the value of the secure hardware monotonic counter 204 that is also accessed through the security firmware 205.

The electronic equipment 600 further comprises a means for utilizing. The means for utilizing utilizes the MAC key 202 stored in the hardware hardware security module 104 that it accesses through the security firmware 205. The electronic equipment 600 further comprises a means for generating. The means for generating generates a MAC value 112. In an embodiment of the invention, the security code 105 utilizes the MAC key 202 that it accesses through the security firmware 205 and the meta-file 110, to generate the MAC value 112. The electronic equipment 600 further comprises a means for storing. The means for storing stores the MAC value 112 with the meta-file 110 in the memory module 106. The electronic equipment 600 further comprises a means for comparing. The means for comparing compares the MAC value 112 generated by the security code 105 and the MAC value 112 stored with the meta-file 110, the MAC value 112 being accessed through the security firmware 205. Further, the means for comparing compares the value stored in the secure hardware monotonic counter 204 with the identifier value 206 stored in the meta-file 110. The electronic equipment 600 further comprises a means for denying access. The means for denying access denies access to the information stored in the electronic equipment 600 when the MAC value 112 generated by using the security code 105 does not match the MAC value 112 stored with the meta-file 110. Further, the means for denying access denies access to the information stored in the electronic equipment 600 when the value stored in the secure hardware monotonic counter 204 that is accessed through the security firmware 205 does not match the identifier value 206 stored in the meta-file 110.

It will be appreciated the method and system described herein may be comprised of one or more conventional processors and unique stored program instructions that control the one or more processors to implement, in conjunction with certain non-processor circuits, some, most, or all of the functions of the method described herein. The non-processor circuits may include, but are not limited to, a radio receiver, a radio transmitter, signal drivers, clock circuits, power source circuits, and user input devices. As such, these functions may be interpreted as steps of a method to protect information stored in an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for protecting information stored in an electronic device, the method comprising:
calculating a message authentication code (MAC) value for a meta-file, the meta-file comprising file information for at least one file in the electronic device; and
tagging the meta-file with an identifier value, the identifier value being same as a value stored in a secure hardware monotonic counter, the identifier value being stored in the meta-file.

2. A method of protecting information as recited in claim 1, wherein calculating the MAC value comprises:
utilizing a MAC key, the MAC key stored in a hardware security module, the MAC key being accessible through a security code; and
generating the MAC value, the MAC value being generated by the security code, the security code using the MAC key and the meta-file.

3. A method of protecting information as recited in claim 1 further comprising:
storing the MAC value with the meta-file.

4. A method of protecting information as recited in claim 1 further comprising:
identifying an illegal copy of the at least one file in the electronic device.

5. A method of protecting information as recited in claim 4, wherein identifying the illegal copy comprises:
generating a MAC value for the meta-file, the MAC value being generated by a security code using a MAC key;
comparing the MAC value generated using the security code with the MAC value stored with the meta-file; and
comparing the value stored in the secure hardware monotonic counter with the identifier value stored in the meta-file.

6. A method of protecting information as recited in claim 5 further comprising:
denying access to the information stored in the electronic device when the MAC value generated using the security code does not match the MAC value stored with the meta-file.

7. A method of protecting information as recited in claim 5 further comprising:
denying access to the information stored in the electronic device when the value stored in the secure hardware monotonic counter does not match the identifier value stored in the meta-file.

8. A system for protecting information stored in an electronic device, the system comprising:
a secure hardware monotonic counter, the secure hardware monotonic counter storing a value; and
a MAC key, the MAC key being stored in a protected hardware security module.

9. A system for protecting information as recited in claim 8, wherein information stored in the electronic device comprises one or more of a group comprising data, instructions, software, key hashes, flex bits, identifier values, service information, version information, security code and security information.

10. A system for protecting information as recited in claim 8, further comprising a security code, the security code generating a MAC value using the MAC key.

11. A system for protecting information as recited in claim 8, wherein the value stored in the secure hardware monotonic counter is the same as an identifier value stored in a meta-file.

12. An electronic equipment comprising:
means for calculating a message authentication code (MAC) value for a meta-file, the meta-file comprising file information for at least one file in the electronic device; and
means for tagging the meta-file with an identifier value, the identifier value being same as a value stored in a secure hardware monotonic counter, the identifier value being stored in the meta-file.

13. An electronic equipment as recited in claim 12, further comprising:
means for utilizing a MAC key, the MAC key stored in a hardware security module, the MAC key being accessible through a security code.

14. An electronic equipment as recited in claim 13, further comprising:
means for generating the MAC value, the MAC value being generated by the security code, the security code using the MAC key and the meta-file.

15. An electronic equipment as recited in claim 14 further comprising:
means for storing the MAC value with the meta-file.

16. An electronic equipment as recited in claim 12 further comprising:
means for generating a MAC value for the meta-file, the MAC value being generated by a security code using a MAC key.

17. An electronic equipment for protecting information as recited in claim 16 further comprising:
means for comparing the MAC value generated using the security code with the MAC value stored with the meta-file.

18. An electronic equipment as recited in claim 17 further comprising:
means for denying access to the information stored in the electronic equipment when the MAC value generated using the security code does not match the MAC value stored with the meta-file.

19. An electronic equipment as recited in claim 12 further comprising:
means for comparing the value stored in the secure hardware monotonic counter with the identifier value stored in the meta-file.

20. An electronic equipment as recited in claim 19 further comprising:
means for denying access to the information stored in the electronic equipment when the value stored in the secure hardware monotonic counter does not match the identifier value stored in the meta-file.
